(19) United States
(12) Patent Application Publication
(10) Pub. No.: US 2004/0045116 A1
(43) Pub. Date: Mar. 11, 2004

(54) Windshield wiper having a single-rail spline

(76) Inventors: Tibor Siklosi, Weatherford, TX (US); Subramaniam Shanmugham, Fort Worth, TX (US); Victor K. Paulsen, Mineral Wells, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 10/241,028

(22) Filed: Sep. 11, 2002

(51) Int. Cl. B60S 1/38; B60S 1/04

(52) U.S. Cl. 15/250.451; 15/250.452

(57) ABSTRACT

A wiper assembly having a wiper frame, a wiper blade, and a single-rail spline is provided. The wiper blade includes a head portion and a wiping portion, the head portion having an entry slot disposed in a top surface of the head portion. A spline channel is also disposed in the head portion adjacent to the entry slot. A single-rail spline nests within the spline channel and adds rigidity to the wiper blade along the length of the wiper blade. The wiper blade and spline are slidingly received by claws on the wiper frame, and an end cap is releasably connected to both ends of the wiper blade to further secure the wiper blade and spline to the wiper frame.

### BACKGROUND OF THE INVENTION

1. Field of the Invention

This invention relates generally to windshield wiper assemblies, and more particularly to a windshield wiper having a single-rail spline that improves the performance and decreases the manufacturing costs of the windshield wiper.

2. Description of Related Art

A critical problem encountered by windshield wiper designers has been how to maintain contact between a wiper blade and a windshield at all times throughout the windshield wiping process. One complicating factor is that a particular wiper blade may be designed to fit on many different automobile models. Different automobiles typically have windshields of different sizes and shapes, and providing contact between the windshield and all parts of a wiper blade can be a difficult task. One design solution to the problem has been to provide wiper frames having spring-like flexural members attached to the frames. The flexural members exert forces at various points along the wiper blade to insure contact of the blade with the windshield.

The wiper blade portion of a windshield wiper assembly typically is made of an elastomeric material and includes a wiping portion and a head portion. The head portion of the wiper blade attaches to the frame of the wiper assembly, and it is typically desirable to include a stiffening member, which improves the connection between the wiper blade and the frame. The stiffening member, often referred to as a “spline,” adds rigidity to the head portion of the wiper blade, and helps insure that the wiper blade conforms to the curvature of the windshield.

Referring to FIG. 3 in the drawings, a cross-sectional view of a wiper blade 52 having a dual-rail spline 53 is illustrated. Wiper blade 52 includes a head portion 57 and a wiping portion 58. Head portion 57 includes a top surface 59 and two side surfaces 61. A groove 63 is disposed in each of side surfaces 61 for receiving dual-rail spline 53. Dual-rail spline 53 is actually two individual, flat pieces of metal that add rigidity to head portion 57. Dual-rail spline 53 is disposed within two separate grooves 63 on opposing sides of head portion 57.

Wiper blade 52 is typically installed on a wiper frame using claws 65 that surround and grip an upper part of head portion 57 and dual-rail spline 53. In order to prevent sliding of the wiper blade 52 within claws 65, the claws 65 are crimped around head portion 57 at various points along the length of wiper blade 52. One disadvantage of dual rail splines is that the crimping locally distorts the profile of wiping portion 58, which reduces the performance of the wiper blade in the area surrounding the crimp.

The dual-rail spline also presents several disadvantages related to the costs of manufacturing and assembly. Since two separate splines are required, manufacturing costs are increased. A related cost increase is apparent in assembly, since it is more difficult and time consuming to install two flat splines in two separate grooves than it is to assemble a wiper assembly having fewer parts. In some dual-rail spline designs, a more complicated head portion is provided to prevent movement of the dual-rail splines relative to the wiper blade. Most of these designs require a molding process to manufacture the wiper blade, which is much more expensive than extrusion processes.

Another disadvantage is the higher likelihood of failure associated with two separate splines, as opposed to one integrated spline. Only one of the splines has to be broken, bent, or otherwise damaged to degrade the overall performance of the wiper. Additionally, if ice, snow, or sleet enters either of the grooves surrounding the spline, the flexibility of the wiper blade is decreased, which decreases the wiping ability of the wiper blade. Following installation of the wiper assembly on a vehicle, the upward facing groove on the dual-rail spline design is especially susceptible to ice, snow, or sleet penetration.

Referring to FIG. 4 in the drawings, another existing spline variation is illustrated. Wiper blade 71 includes a head portion 73 and a wiping portion 75. A plastic spline 77 envelopes an upper part of the head portion 73 and fits into grooves 79 disposed on opposing sides of head portion 73. The plastic spline 77, like dual-rail spline 53 of FIG. 3, adds rigidity to the wiper blade 71. Wiper blade 71 is attached to a wiper frame (not shown) using claws 81 that slidably grip the head portion 73 and plastic spline 77. End caps (not shown) are typically installed at both ends of wiper blade 71 to prevent the wiper blade 71 from sliding out of claws 81. Because of the use of the end caps, it is not necessary to crimp the claws 81 to wiper blade 71. This prevents distortion of the wiper blade 71, thereby allowing normal wiping performance.

Another plastic spline 85 is illustrated in FIG. 5. Similar to plastic spline 77 of FIG. 4, spline 85 surrounds a head portion 89 of wiper blade 87. Plastic spline 85 is of unitary construction and has an “omega” shape. A claw 91 slidably grips plastic spline 85 and head portion 89 to attach wiper blade 87 to a wiper frame (not shown). End caps are installed on both ends of wiper blade 87 to prevent wiper blade 87 from becoming disengaged from claws 91.

The primary disadvantage to plastic splines is the susceptibility of the plastic to deformation when exposed to extreme heat. Since wiper blades are often used on automobiles in hot climates, it is not desirable to have a spline material that is easily deformable. If the spline changes shape, the wiping portion of the wiper blade is subject to distortion, which decreases the wiping performance of the blade.

U.S. Pat. No. 5,893,193 describes a windshield wiper blade that includes a longitudinal conduit penetrating the length of the wiper blade. A runner-like spring element is housed within the longitudinal conduit which performs similar to a spline. The primary problem with this spline is that it is completely surrounded on all of its longitudinal sides by the elastomeric wiper blade. Consequently, the wiper blade must either be co-extruded with the spline or molded around the spline. Both of these manufacturing processes involve excessive costs. Additionally, this particular design requires that the wiper blade spring element be crimped by claws for attachment to the wiper frame. Crimping of the wiper blade prevents wiper blade replacement unless the entire wiper frame is also replaced.

A need exists, therefore, for a wiper having a spline that overcomes the problems presented by existing splines. Specifically, a spline is needed that is constructed of rugged material that is not susceptible to extreme changes in temperature. A spline is further needed that involves a minimal number of parts and that is easily incorporated with a wiper blade, thereby reducing the costs of manufacturing and assembly. The reduced number of parts should also provide fewer opportunities for spline failure, decreasing the likelihood of performance diminutions. A spline is further needed that, upon incorporation with the wiper assembly, is less susceptible to harsh weather conditions, especially snow, sleet, and ice. Finally, a spline is needed that does not require crimping of claws around the wiper blade for installation on the wiper frame. By eliminating crimping of the wiper blade, the performance of the wiper blade is improved, and the blade is easily replaceable.

### BRIEF SUMMARY OF THE INVENTION

The problems presented by existing splines and wiper blades are solved by the present invention. A wiper blade having a wiping portion, a head portion, and a single-rail spline is provided. The head portion is connected to the wiping portion and includes a spline channel and a an entry slot, both the spline channel and the entry slot extending longitudinally along the head portion. The entry slot is adjacent to the spline channel, and preferably, at least one retention shoulder is disposed laterally adjacent to the entry slot.

When assembling the wiper blade, the single-rail spline is inserted through the entry slot and is received by the spline channel. The retention shoulders are elastically deformed to allow insertion of the single-rail spline, but the retention shoulders rebound to secure the spline within the spline channel.

A wiper assembly having a wiper frame, a wiper blade, and a single-rail spline is also provided by the present invention. The single-rail spline nests within a spline channel on the wiper blade and is secured by at least one retention shoulder disposed on the wiper blade. A frame attachment groove is disposed on the wiper blade to slidingly receive a plurality of blade-receiving members on the wiper frame.

The single-rail spline includes one of either a connection tab or a recess (or hole), and an end cap includes the other of either the connection tab or the recess. The end cap includes a projection member that is slidingly received by the frame attachment groove on the wiper blade. The end cap is releasably locked to the wiper blade and spline by the mating engagement of the tab and the recess, thereby preventing the wiper and spline from becoming disengaged from the blade-receiving members on the wiper frame.

Other objects, features, and advantages of the present invention will become apparent with reference to the drawings and detailed description that follow.

### BRIEF DESCRIPTION OF THE DRAWINGS

FIG. 1 illustrates a front view of a wiper assembly according to the present invention, the wiper assembly including a wiper frame having a blade-receiving member, a wiper blade, a single-rail spline, and an end cap;

FIG. 2A depicts a perspective view of the wiper blade and single-rail spline of FIG. 1;

FIG. 2B illustrates a front view of the end cap of FIG. 1;

FIG. 2C depicts a top view of the end cap of FIG. 1;

FIG. 2D illustrates a side view of the end cap of FIG. 1;

FIG. 2E depicts a cross-sectional front view of the end cap of FIG. 1 taken at IIE-IIE in FIG. 2D.

FIG. 3 illustrates a cross-sectional side view of a prior art wiper blade having a dual-rail spline;

FIG. 4 depicts a cross-sectional side view of a prior art wiper blade having a conventional plastic spline; and

FIG. 5 illustrates a cross-sectional side view of a prior art wiper blade having an “omega” plastic spline.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, structural, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

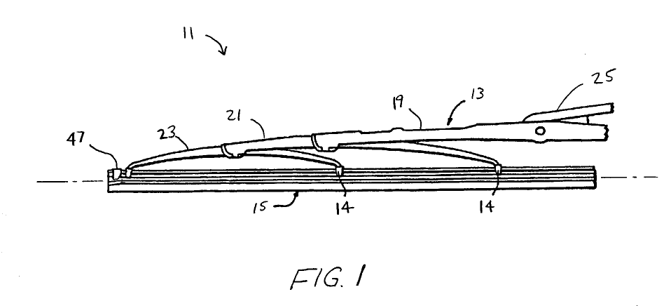

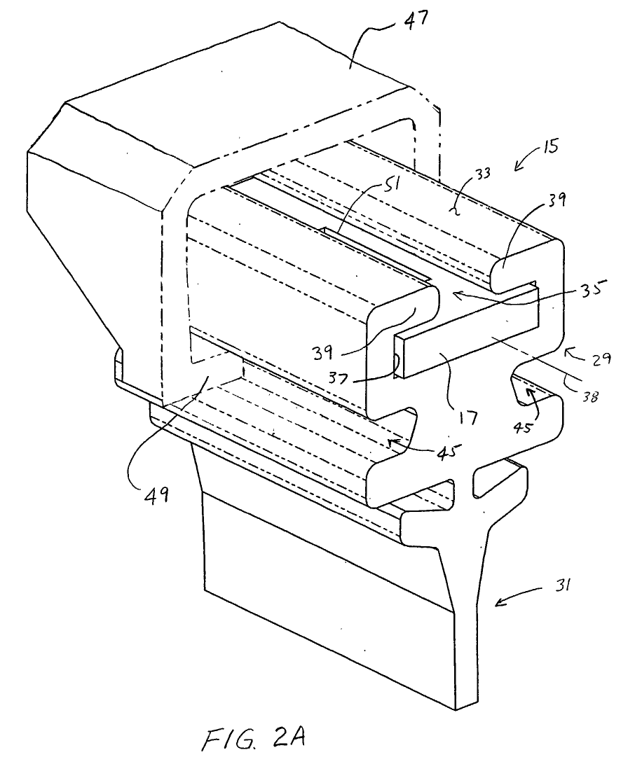

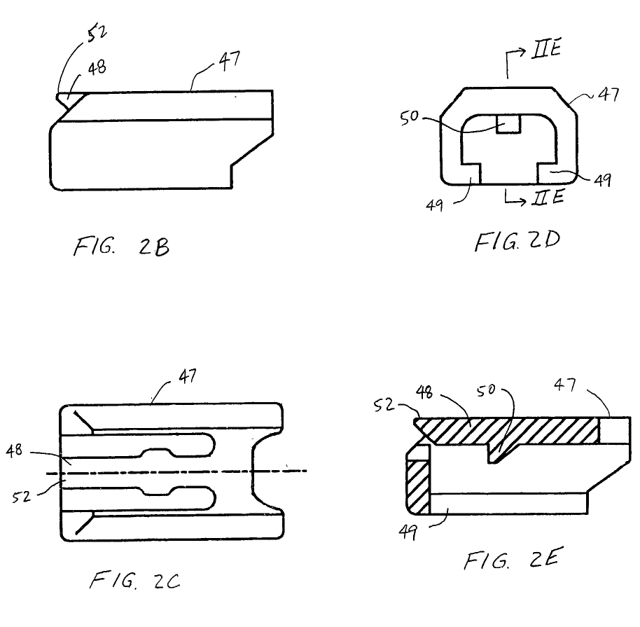

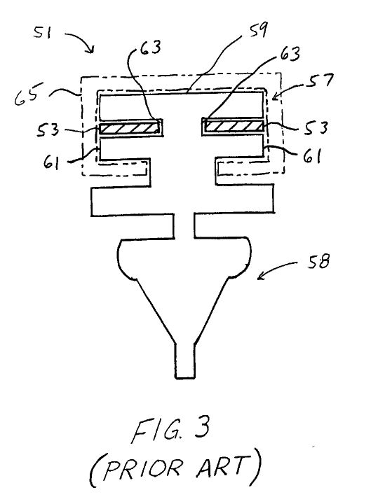

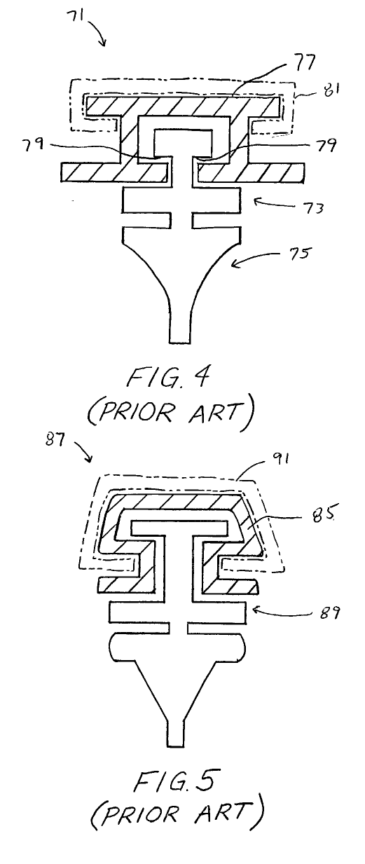

Referring to FIGS. 1 and 2A in the drawings, a wiper assembly 11 having a wiper frame 13, a plurality of blade-receiving members 14, a wiper blade 15, and a single-rail spline 17 is illustrated. Wiper blade 15 and single-rail spline 17 are slidingly received by blade-receiving members 14 disposed on wiper frame 13. Wiper frame 13 is of traditional design and includes a primary frame portion 19, two secondary frame portions 21, and a plurality of tertiary frame portions 23. Secondary and tertiary frame portions 21, 23, also referred to as “bridges,” are flexural members that help maintain contact between wiper blade 15 and a windshield (not shown). Secondary frame portions 21 are pivotally connected to both ends of primary frame portion 19. Tertiary frame portions 23 are pivotally connected to each end of the secondary frame portions 21. Together, the primary, secondary, and tertiary frame portions exert forces on multiple portions of wiper blade 15 so that the wiper blade 15 contacts, and thereby wipes, a windshield more effectively.

When installed on an automobile, airplane or other vehicle having a windshield, the primary frame portion 19 is pivotally connected to a wiper arm 25. The wiper arm either rotates or translates relative to the windshield such that the wiper blade is dragged across the surface of the windshield. As the wiper blade moves across a windshield having a contour, the force exerted at the end of each frame portion (i.e. primary 19, secondary 21, or tertiary 23) coupled with the ability of each frame portion to pivot relative to the wiper arm and the other frame portions allows the wiper blade 15 to bend and conform to the shape of the windshield.

Although wiper blade 15 is designed to flex and conform to the shape of a contoured surface, it is preferred that wiper blade 15 retain some spring-like rigidity to oppose the forces imposed by the contoured surface, as well as the primary, secondary, and tertiary frame portions. The wiper blade rigidity further assists in providing full contact between the wiper blade 15 and the surface being wiped. Wiper blade 15 is combined with single-rail spline 17 to provide the required rigidity along the length of wiper blade 15.

Referring more specifically to FIG. 2A, wiper blade 15 includes a head portion 29 and a wiping portion 31. Head portion 29 includes an upper surface 33 having an entry slot 35. A spline channel 37 is disposed within head portion 29 and is adjacent to and communicable with entry slot 35. Preferably, both entry slot 35 and spline channel 37 extend the entire length of wiper blade 15 parallel to a longitudinal axis 38 of head portion 29. In a preferred embodiment, entry slot 35 is not as wide as spline channel 37, and a retention shoulder 39 is disposed on each side of entry slot 35. Retention shoulder 39 is flexible, and is therefore configured to bend away from entry slot 35 while single-rail spline 17 is inserted into spline channel 37. After spline 17 is seated within spline channel 37, both retention shoulders 39 rebound to secure spline 17 within spline channel 37.

A person having skill in the art will recognize that the presence of retention shoulder 39 is not absolutely necessary and that in such a scenario, entry slot 35 would be at least as wide as spline channel 37 and the spline 17 would most likely be secured by a friction fit between spline 17 and the walls of spline channel 37. It is also conceivable that only one retention shoulder 39 is provided that extends from one side of head portion 15 and either partially or completely covers spline 17. Finally, it is possible that entry slot 35 could be disposed on a surface of head portion 15 other than top surface 33. For example, the entry slot 35 could be located on a side surface of head portion 15, as long as the entry slot 35 is still communicable with and adjacent to spline channel 37.

Head portion 15 also includes two frame attachment grooves 45 that extend the length of wiper blade 15. Frame attachment grooves 45 are configured to slidingly receive blade-receiving members 14. Blade-receiving members 14, sometimes also referred to as “claws,” have protrusions that fit into grooves 45. Although the blade-receiving members used with some wiper frames are crimped around the wiper blade, it is preferred in the present invention not to crimp the blade-receiving members 14, but instead to allow the wiper blade 15 to slide within the protrusions. When slidingly installed on blade-receiving members 14, the wiper blade 15 is further secured with a pair of end caps 47. One end cap 47 is installed on each end of wiper blade 15 to prevent wiper blade 15 from sliding out of the grasp of the blade-receiving members 14.

Referring still to FIG. 2A in the drawings, end cap 47 is only partially shown to better illustrate spline 17. As seen in FIG. 2A, each end cap 47 preferably includes projection members 49 that are configured to slidingly engage frame attachment grooves 45. A more complete illustration of end cap 47 is shown in FIGS. 2B-2E. End cap 47 includes a lever member 48 having a connection tab 50. Connection tab 50 is configured to engage a recess, or hole 51 disposed in each end of spline 17. Preferably, the connection tab 50 is force-biased toward hole 51 by lever member 48 such that the connection tab engages hole 51 as the end cap 47 is slidingly received on the end of wiper blade 15. Engagement of the connection tab by hole 51 prevents end cap 47 from sliding off the end of wiper blade 15. Since an end cap 47 is installed on both ends of wiper blade 15, the wiper blade is prevented from sliding out of the blade-receiving members 14. The end cap 47 is configured to allow removal of connection tab 50 from hole 51 by applying an upward force to a removal end 52 of lever member 48. This allows the end cap 47 to be removed from the wiper blade 15 so that wiper blade 15 can be replaced after becoming worn or damaged.

A person of ordinary skill in the art will recognize that while the preferred end cap 47 contains a connection tab 50 for engaging hole 51, the end cap 47 could be configured with a hole or recess that receives a connection tab disposed on an end of the spline 17. As in the preferred embodiment, the end cap 47 should be removable to allow replacement of wiper blade 15.

Even though many of the examples discussed herein are applications of the wiper assembly having a single-rail spline that is one integral piece, it should be recognized that the single-rail spline could consist of two or more interlocking pieces that are placed within a spline channel on the wiper blade. It should also be noted that the single-rail spline, while preferably made of metal, could be constructed of any material that provides adequate resistance to heat and other extreme weather conditions. Finally, the single-rail spline and wiper blade of the present invention could be used in combination with any size or style of wiper frame.

From the foregoing, it will be recognized that the single-rail spline of the present invention provides a superior system for providing rigidity to a wiper blade, thereby allowing the wiper blade to fully contact a wiping surface for effective and efficient wiping. The single-rail spline is easily insertable through an entry slot in the head portion of the wiper blade and nests in a spline channel of the wiper blade. Since the spline is preferably made of a single piece of material and is manufactured separately from the wiper blade, the manufacturing costs and assembly costs are less than traditional designs using multiple splines or using splines that are co-extruded with the wiper blade.

The ability of the spline to engage an end cap provides additional advantages not seen in splines that are substantially covered by portions of the wiper blade. Since end caps are used with the spline and wiper blade of the present invention, the blade-receiving members do not have to be crimped to the wiper blade to secure the wiper blade to the wiper frame. Instead the wiper blade and spline are slidably received by the blade retaining members, which prevents performance degradation often seen with wiper blades that are crimped. The removable end caps also allow the wiper blades and splines to be replaced after experiencing wear or damage.

Still another advantage is provided by the retention shoulders disposed on the head portion of the wiper frame. The retention shoulders rebound after insertion of the single-rail spline in the spline channel and prevent the single-rail spline front becoming dislodged from the wiper blade. The retention shoulders also provide an effective barrier to ice, snow, and sleet that otherwise may penetrate the spline channel and degrade the performance of the wiper blade.

Finally, since the spline of the present invention is preferably made of metal, exposure to extreme temperatures does not inflict damage on the spline and subsequent performance loss on the wiper blade. This presents a substantial advantage over the use of plastic splines that often deform in extremely hot temperatures, thereby altering the profile of the wiper blade and decreasing wiper performance.

It should be apparent from the foregoing specification that an invention having significant advantages has been provided. While the invention is shown in only a few of its forms, it is not just limited but is susceptible to various changes and modifications without departing from the spirit thereof.

We claim:

1. A wiper blade comprising:
a wiping portion;
a head portion connected to the wiping portion, the head portion including a spline channel extending longitudinally along the head portion, the head portion further including an entry slot in a surface of the head portion, the entry slot being adjacent the spline channel; and
a single-rail spline capable of being inserted through the entry slot and configured to nest within the spline channel.

2. A wiper blade according to claim 1, wherein:
the single-rail spline includes one of a connection tab and a recess adapted to received the other of the connection tab and the recess disposed on an end cap; and
the single-rail spline and head portion are adapted to be secured to a wiper frame by the end cap.

3. A wiper blade according to claim 1, wherein:
the head portion further comprises a pair of frame attachment grooves that extend the length of the wiper blade; and
each frame attachment groove is configured to receive a projection member disposed on an end cap for securing the single-rail spline and head portion to a wiper frame.

4. A wiper blade according to claim 1 further comprising:
at least one frame attachment groove disposed on the head portion that extends the length of the head portion;
an end cap having at least one projection member and one of a connection tab and a recess;
wherein the single-rail spline includes another of the connection tab and the recess;
wherein the frame attachment groove is configured to receive the projection member of the end cap; and
wherein the one of the connection tab and the recess on the end cap is configured to matingly engage the other of the connection tab and the recess on the single-rail spline.

5. A wiper blade according to claim 1, wherein a neck portion connects the head portion to the wiping portion.

6. A wiper blade according to claim 1, wherein the single-rail spline is made of metal.

7. A wiper blade comprising:
a wiping portion;
a head portion integrally connected to the wiping portion by a neck portion;
a spline channel disposed along the length of the head portion parallel to a longitudinal axis of the head portion;
an entry slot disposed in a top surface of the head portion, the entry slot being adjacent the spline channel;
at least one retention shoulder disposed laterally adjacent to the entry slot;
a single-rail spline releasably nested within the spline channel; and
wherein the retention shoulder secures the single-rail spline within the spline channel.

8. A wiper blade according to claim 7, wherein:
the head portion further comprises a pair of frame attachment grooves that extend the length of the wiper blade; and
each frame attachment groove is configured to receive a projection member disposed on an end cap for securing the single-rail spline and head portion to a wiper frame.

9. A wiper blade according to claim 7, wherein:
the single-rail spline includes one of a connection tab and a recess adapted to receive the other of the connection tab and the recess disposed on an end cap; and
the single-rail spline is adapted to be secured to a wiper frame by the end cap.

10. A wiper blade according to claim 7 further comprising:
at least one frame attachment groove disposed on the head portion that extends the length of the head portion;
an end cap having at least one projection member and one of a connection tab and a recess;
wherein the single-rail spline includes another of the connection tab and the recess;
wherein the frame attachment groove is configured to receive the projection member of the end cap; and
wherein the one of the connection tab and the recess on the end cap is configured to matingly engage the other of the connection tab and the recess on the single-rail spline.

11. A wiper blade according to claim 7, wherein the single-rail spline is made of metal.

12. A wiper assembly comprising:
a wiper frame having a blade-receiving member;
a wiper blade releasably connected to the blade-receiving member of the wiper frame, the wiper blade having a wiping portion and a head portion integrally connected by a neck portion, the head portion further including a spline channel extending along the length of the head portion, the head portion further including an entry slot in a top surface of the head portion, the entry slot being adjacent the spline channel; and
a single-rail spline capable of being inserted through the entry slot and configured to nest within the spline channel.

13. A wiper assembly according to claim 12 wherein the wiper blade further comprises at least one retention shoulder disposed laterally adjacent to the entry slot.

14. A wiper assembly according to claim 12 further comprising an end cap configured to secure the wiper blade to the frame.

15. A wiper assembly according to claim 12 further comprising:
an end cap;
wherein the single-rail spline includes one of a connection tab and a recess and the end cap includes the other of the connection tab and the recess; and
wherein the connection tab and recess are configured to matingly engage such that the end cap is secured to the single-rail spline.

16. A wiper assembly according to claim 12 further comprising:
an end cap; and
wherein the wiper blade further includes at least one frame attachment groove that extends the length of the wiper blade and is configured to receive a projection member disposed on the end cap for securing the end cap to the wiper blade.

17. A wiper assembly according to claim 12 further comprising:
an end cap having at least one projection member and one of a connection tab and a recess;
wherein the single-rail spline includes the other of the connection tab and the recess for mating with the one of the connection tab and the recess disposed on the end cap;
wherein the wiper blade includes at least one frame attachment groove disposed on the wiper blade that extends the length of the wiper blade;
wherein the frame attachment groove is configured to receive the blade-receiving member of the wiper frame;
wherein the frame attachment groove is configured to receive the projection member of the end cap to secure the end cap to the wiper blade; and
wherein the one of the connection tab and the recess on the end cap is configured to matingly engage the other of the connection tab and the recess on the single-rail spline to secure the end cap to the single-rail spline.

18. A wiper assembly according to claim 12, wherein the single-rail spline is made of metal.

19. A wiper assembly according to claim 12, wherein the wiper blade is made of a flexible material.
